(19) United States
(12) Patent Application Publication
(10) Pub. No.: US 2009/0168116 A1
(43) Pub. Date: Jul. 2, 2009

(54) Method and System For Calibrating A Scanner Having A Scan Bar Including Sensor Elements

(76) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/964,183

(22) Filed: Dec. 26, 2007

(51) Int. Cl. H04N 1/04; H04N 1/00; H04N 1/46

(52) U.S. Cl. 358/474; 358/406; 358/504

(57) ABSTRACT

A scanner includes a scan bar and a calibration strip. The scan bar has perpendicular fast-scan and slow-scan axes. The scan bar has an image sensor plane and includes a substantially linear array of sensor elements substantially aligned along the fast-scan axis. A first method for calibrating the scan bar includes imaging the calibration strip to the image sensor plane of the scan bar wherein the imaging is out of focus substantially-along the slow-scan axis. The first method also includes obtaining a calibration reading of the sensor elements from the imaging of the calibration strip. A second method includes imaging the calibration strip to the image sensor plane of the scan bar wherein the imaging is optically widened substantially-along the slow-scan axis. In a third method, the imaging is optically widened substantially-along the slow-scan axis using a cylindrical lens having an imaging-widening axis.

### TECHNICAL FIELD

The present invention relates generally to scanners, and more particularly to a method for calibrating a scanner having a scan bar including sensor elements.

### BACKGROUND OF THE INVENTION

Scanners are used to scan an image to create a scanned image which can be displayed on a computer monitor, which can be used by a computer program, which can be printed, which can be faxed, etc. One conventional scanner includes a scan bar and a white calibration strip. The scan bar has a fast-scan axis and a slow-scan axis aligned perpendicular to the fast-scan axis. The scan bar has an image sensor plane and includes a substantially-linear array of optical sensor elements, such as charge-coupled-device (CCD) elements substantially-aligned along the fast-scan axis. Each sensor element produces a signal proportional to the amount of light reaching the element. The proportion or “gain” of each element is related but not identical. In addition, the light source may not uniformly illuminate the document to be scanned. To get an image with a consistent representation, the elements should be individually calibrated using at least the calibration strip.

Calibration provides a revised gain for each sensor element to compensate for varying amounts of illumination produced by a scanner light source in different regions of the scanned image and to compensate for variations among the CCD elements of the scan bar. However, optical defects such as dust or debris on the calibration strip may cause the calibration of sensor elements which read the optical defects or blemishes to be inaccurate. When printing a scanned document, inaccurate calibration of a sensor element may result in streaking (i.e., a printed vertical column which will be brighter than neighboring columns).

For calibration, the calibration strip is imaged using at least a scanner lens to the image sensor plane of the scan bar. A calibration reading of the sensor elements is taken from the imaging of the calibration strip, and each sensor element is calibrated from at least one of the calibration readings using known calibration algorithms Scanners which allow the scan bar and/or the calibration strip to be moved will take an average of calibration readings of many (e.g., 255) different scan-bar lines of the calibration strip, wherein such averaging may make the optical defect insignificant However, some scanners have an automatic document feeder configuration for which the scan bar and the calibration strip are immobile. For these scanners, a calibration reading of the sensor elements can be taken from only a single scan-bar line of the calibration strip. A known technique for these scanners prevents streaking by using additional software to identify an invalid reading from an optical defect as an improbable sudden change in a calibration reading of the next sensor element and to replace such reading with a derived value based on valid sensor readings of neighboring sensor elements.

What is needed is an improved system and method for calibrating a scanner having a scan bar including sensor elements.

### SUMMARY

A first method of the present invention is for calibrating a scanner having a scan bar and a calibration strip. The scan bar has a fast-scan axis and a slow-scan axis aligned perpendicular to the fast-scan axis. The scan bar has an image sensor plane and includes a substantially-linear array of sensor elements substantially-aligned along the fast-scan axis. The first method includes imaging the calibration strip to the image sensor plane of the scan bar wherein the imaging is out of focus substantially-along the slow-scan axis. The first method also includes obtaining a calibration reading of the sensor elements from the imaging of the calibration strip.

A second method of the present invention is for calibrating a scanner having a scan bar and a calibration strip. The scan bar has a fast-scan axis and a slow-scan axis aligned perpendicular to the fast-scan axis. The scan bar has an image sensor plane and includes a substantially linear array of sensor elements substantially aligned along the fast-scan axis. The second method includes imaging the calibration strip to the image sensor plane of the scan bar wherein the imaging is optically widened substantially-along the slow-scan axis. The second method also includes obtaining a calibration reading of the sensor elements from the imaging of the calibration strip.

A scanner of the present invention includes a scan bar, a calibration strip, and a scanner lens. The scan bar has a fast-scan axis and a slow-scan axis aligned perpendicular to the fast-scan axis. The scan bar has an image sensor plane. The scanner also includes a cylindrical lens having an imaging-widening axis, wherein the cylindrical lens is disposed between at least one of the calibration strip and the scanner lens and the scanner lens and the image sensor plane, with the imaging-widening axis aligned substantially-parallel to the slow-scan axis.

Several benefits and advantages are derived from the first and/or second methods and from the scanner of the present invention. In one example, in a scanner having an automatic document feeder configuration with an immobile scan bar and an immobile calibration strip, the conventional need is avoided for additional software and computing time to identify an invalid reading from an optical defect as an improbable sudden change in a calibration reading of the next sensor element and to replace such reading with a derived value based on valid sensor readings of neighboring sensor elements.

### BRIEF DESCRIPTION OF THE DRAWINGS

FIG. 1 is a block diagram of a first method of the present invention;

FIG. 2 is a schematic diagram of an embodiment of a scanner which may be employed in performing the first, second, and/or the third method of the present invention;

FIG. 3 is a block diagram of a second method of the present invention; and

FIG. 4 is a block diagram of a third method of the present invention.

### DETAILED DESCRIPTION

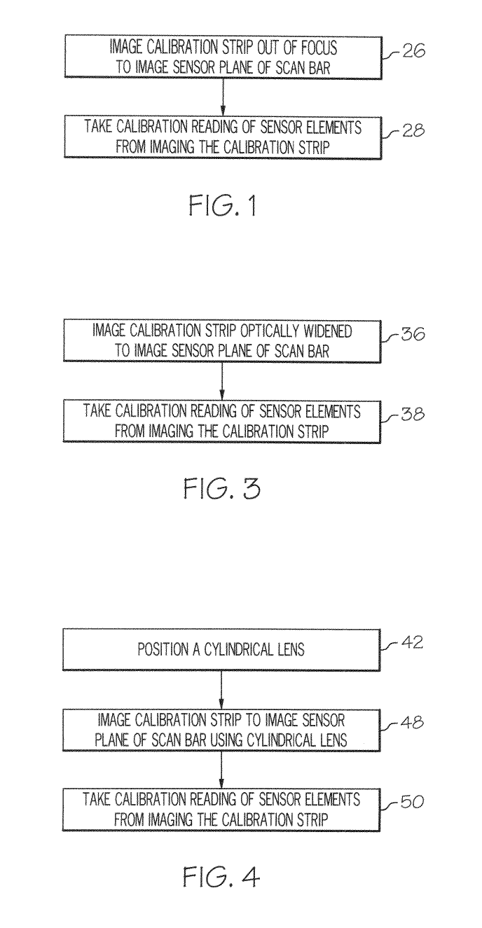

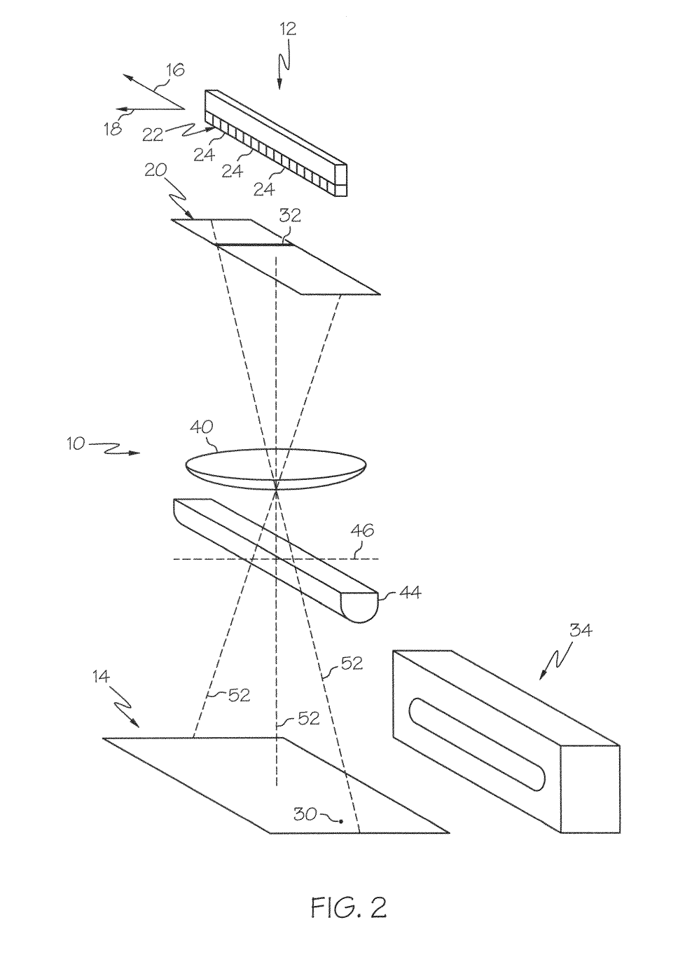

A first method of the present invention, with reference to FIGS. 1 and 2, is for calibrating a scanner 10 having a scan bar 12 and a calibration strip 14. The scan bar 12 has a fast-scan axis 16 and a slow-scan axis 18 aligned perpendicular to the fast-scan axis 16. The scan bar 12 has an image sensor plane 20 and includes a substantially-linear array 22 of sensor elements 24 substantially-aligned along the fast-scan axis 16. The first method includes, as summarized in block 26 of FIG. 1, imaging the calibration strip 14 to the image sensor plane 20 of the scan bar 12 wherein the imaging is out of focus substantially along the slow-scan axis 18. The first method also includes, as summarized in block 28 of FIG. 1, taking a calibration reading of the sensor elements 24 from the imaging of the calibration strip 14.

It is noted that sensor element is to be understood as an optical sensor element such as, but not limited to a charge-coupled-device (CCD) element. It is also noted that the substantially linear array of sensor elements need not include every scan bar sensor element which lies substantially along the fast-scan axis of the scan bar. In one example, outlying sensor elements and/or defective sensor elements are not included, as can be appreciated by those skilled in the art. It is further noted that an image which is out of focus is blurred substantially along the slow-scan axis.

In one example of the first method, the imaging is of a white area of the calibration strip 14. In FIG. 2, a dot 30 represents a dark dust particle on the calibration strip 14 which has been blurred or optically widened along the slow-scan axis 18 as a line 32 on the image sensor plane 20.

In one implementation of the first method, the imaging is in focus substantially-along the fast-scan axis 16.

In one application of the first method, the scanner 10 has an automatic document feeder configuration (e.g., as represented in FIG. 2). In one employment, after calibration, a user feeds a document (not shown) into the automatic document feeder 34 which moves the document in the direction of the slow-scan axis 18 and just in front of (i.e., to the right of in FIG. 2) the calibration strip 14. In one variation, the scanner includes a flatbed scanner configuration. In a different variation, the scanner lacks a flatbed scanner configuration.

In one enablement of the first method, the scan bar 12 and the calibration strip 14 are immobile when the scanner 40 is in the automatic document feeder configuration (such as the backside configuration of an automatic document feeder that is capable of a duplex scan). In one employment of the first method, the imaging and the calibration reading are performed when the scanner 40 is in the automatic document feeder configuration. In one extension of the first method, sensor elements 24 may be calibrated using at least one of calibration reading of the sensor elements 24. It is noted that while a calibration strip 14 is typically white in color, that some calibration techniques use a non-white light color instead of a white color calibration strip. In some embodiments, an additional calibration reading of the white (or light-colored) calibration strip with the lights off or an additional calibration reading of an additional black area of the otherwise white (or light-colored) calibration strip may be used in some calibration techniques, as is known to those skilled in the art.

A second method of the present invention is for calibrating a scanner 10 having a scan bar 12 and a calibration strip 14. The scan bar 12 has a fast-scan axis 16 and a slow-scan axis 18 aligned perpendicular to the fast-scan axis 16. The scan bar 12 has an image sensor plane 20 and includes a substantially linear array 22 of sensor elements 24 substantially aligned along the fast-scan axis 16. The second method includes, as summarized in block 36 of FIG. 3, imaging the calibration strip 14 to the image sensor plane 20 of the scan bar 12 wherein the imaging is blurred or optically widened substantially along the slow-scan axis 18. The second method also includes, as summarized in block 38 of FIG. 3, taking a calibration reading of the sensor elements 24 from the imaging of the calibration strip 14.

In one implementation of the second method, the imaging is not optically widened substantially along the fast-scan axis 16.

It is noted that the applications, enablements, etc. of the first method are equally applicable to the second method.

A third method of the present invention is for calibrating a scanner 10 having a scan bar 12, a calibration strip 14, and a scanner lens 40. The scan bar 12 has a fast-scan axis 16 and a slow-scan axis 18 aligned perpendicular to the fast-scan axis 16. The scan bar 12 has an image sensor plane 20 and includes a substantially linear array 22 of sensor elements 24 substantially-aligned along the fast-scan axis 16. The third method includes, as summarized in block 42 of FIG. 4, disposing a cylindrical lens 44 having an imaging-widening axis 46, wherein the cylindrical lens 44 is disposed between the calibration strip 14 and the scanner lens 40, or between the scanner lens 40 and the image sensor plane 20, with the imaging-widening axis 46 aligned substantially parallel to the slow-scan axis 18. The third method also includes as summarized in block 50 of FIG. 4, imaging the calibration strip 14 to the image sensor plane 20 of the scan bar 12 using at least the cylindrical lens 44 and the scanner lens 32, wherein the imaging is blurred or optically widened substantially along the slow-scan axis 18 due to the disposed and aligned cylindrical lens 44. The third method also includes, as summarized in block 52 of FIG. 4, taking a calibration reading of the sensor elements 24 from the imaging of the calibration strip 14.

It is noted that the implementations of the second method and the applications, enablements, etc. of the first method are equally applicable to the third method.

In one employment of the second and/or the third method, the imaging is optically widened at least two times. In one variation, the imaging is optically widened at least ten times. In one utilization of the third method, the cylindrical lens 44 is disposed between the calibration strip 14 and the scanner lens 32.

In one arrangement of the third method, the cylindrical lens 44 is disposed immediately in front of (i.e., to the left of in FIG. 2) the scanner lens 40 for obtaining a calibration reading of the sensor elements 24. In another arrangement of the third method, not shown, the cylindrical lens 44 is disposed immediately behind the scanner lens 40 for obtaining a calibration reading of the sensor elements 24. In one variation, the optical power of the cylindrical lens 44 is chosen so that the blur size of the imaging along the slow-scan axis 18 makes the presence of a small particle (e.g., dust, debris, etc.) on the calibration strip 14 insignificant to the calibration process Otherwise stated, such blurring of the calibration strip 14 along the slow-scan axis 18 minimizes the effect of small particles on the calibration strip reading. It is noted that such optical widening of the imaging along the slow-scan axis 18 can be said to average out the effect of the small particle the way a scan bar capable of moving along the slow-scan axis can be conventionally used to obtain calibration readings of many different points along the slow-scan axis for each sensor element (i.e., many different scan-bar lines of the calibration strip are read by the scan bar) and average such readings for each sensor element.

In one illustration of the third method, an optical path 52 extends from the calibration strip 14, through the scanner lens 40, and to the image sensor plane 20, and the disposing of the cylindrical lens 44 is performed by swinging the cylindrical lens 44 into a position in the optical path 52 when a calibration reading of the sensor elements 24 is needed. In one variation, the third method also includes swinging the cylindrical lens 44 out of the optical path 38 when the calibration reading of the sensor elements 24 is completed, and a regular scan is to be performed. In one modification, mirrors (not shown) may also be used to create the optical path 52. In one modification, not shown, a mechanical swing arm may be employed to swing the cylindrical lens 44, wherein the mechanical swing arm is electronically controlled by a scanner control unit via a solenoid.

Several benefits and advantages are derived from the first, second, and/or third method of the present invention. In one example, in a scanner having an automatic document feeder configuration with an immobile scan bar and an immobile calibration strip, the conventional needs for additional software and computing time to identify an invalid reading from an optical defect as an improbable sudden change in a calibration reading of the next sensor element and to replace such reading with a derived value based on valid sensor readings of neighboring sensor elements may be avoided.

The foregoing description of several exemplary methods of the present invention has been presented for purposes of illustration. It is not intended to be exhaustive or to limit the invention to the precise actions and/or forms disclosed, and obviously many modifications and variations are possible in light of the above teaching. It is intended that the scope of the present invention be defined by the claims appended hereto.

What is claimed is:

1. A method for calibrating a scanner having a scan bar and a calibration strip, wherein the scan bar has a fast-scan axis and a slow-scan axis aligned perpendicular to the fast-scan axis, an image sensor plane, and a substantially linear array of sensor elements substantially-aligned along the fast-scan axis, comprising:
imaging the calibration strip to the image sensor plane of the scan bar, wherein the imaging is out of focus substantially-along the slow-scan axis; and
obtaining a calibration reading of the sensor elements from the imaging of the 8 calibration strip.

2. The method of claim 1, wherein the imaging is in focus substantially along the fast-scan axis.

3. The method of claim 1 wherein the scanner has an automatic document feeder configuration.

4. The method of claim 3, wherein the scan bar and the calibration strip are immobile when the scanner is operating in the automatic document feeder configuration.

5. The method of claim 3, wherein the imaging and the calibration reading are performed when the scanner is operating in the automatic document feeder configuration.

6. The method of claim 1, further comprising calibrating the sensor elements from at least the calibration reading of the sensor elements.

7. A method for calibrating a scanner having a scan bar and a calibration strip, wherein the scan bar has a fast-scan axis and a slow-scan axis aligned perpendicular to the fast-scan axis, an image sensor plane and a substantially linear array of sensor elements substantially aligned along the fast-scan axis, comprising:
imaging the calibration strip to the image sensor plane of the scan bar wherein the imaging is optically widened substantially along the slow-scan axis; and
obtaining a calibration reading of the sensor elements from the imaging of the calibration strip.

8. The method of claim 7, wherein the imaging is not optically widened substantially-along the fast-scan axis.

9. The method of claim 8 wherein the scanner has an automatic document feeder configuration.

10. The method of claim 9, wherein the scan bar and the calibration strip are immobile when the scanner is operating in the automatic document feeder configuration.

11. The method of claim 10, wherein the imaging and the calibration reading are performed when the scanner is operating in the automatic document feeder configuration.

12. The method of claim 7, further comprising calibrating the sensor elements from at least the calibration reading of the sensor elements.

13. A scanner having a scan bar, a calibration strip, and a scanner lens, wherein the scan bar has a fast-scan axis and a slow-scan axis aligned perpendicular to the fast-scan axis and an image sensor plane comprising a cylindrical lens having an imaging-widening axis, wherein the cylindrical lens is disposed between at least one of the calibration strip and the scanner lens and the scanner lens and the image sensor plane, with the imaging-widening axis aligned substantially parallel to the slow-scan axis.

14. The scanner of claim 13, further comprising an automatic document feeder.

15. The scanner of claim 13, wherein the scan bar and the calibration strip are immobile when the scanner is operating in an automatic document feeder configuration.

16. The scanner of claim 15, wherein said scanner performs imaging and calibration reading in the automatic document feeder configuration.

17. The scanner of claim 16, further comprising the sensor elements.

18. The scanner of claim 16, wherein the imaging is optically widened at least two times.

19. The scanner of claim 13, wherein the cylindrical lens is disposed between the calibration strip and the scanner lens.

20. The scanner of claim 13 wherein the cylindrical lens is disposed between the the scanner lens and the image sensor plane.
